(19) United States
(12) Patent Application Publication
(10) Pub. No.: US 2020/0101804 A1
(43) Pub. Date: Apr. 2, 2020

(54) CONNECTOR FOR CONNECTING TRAILERS IN MOBILE ROBOTIC DEVICE AND METHOD OF CONTROLLING THE SAME

(71) Applicants: Beijing Jingdong Shangke Information Technology Co., Ltd., Beijing (CN); JD.com American Technologies Corporation, Mountain View, CA (US)

(72) Inventor: Zihang Wei, Santa Clara, CA (US)

(21) Appl. No.: 16/147,529

(22) Filed: Sep. 28, 2018

(51) Int. Cl. B60D 1/155; B60D 1/02

(52) U.S. Cl. CPC B60D 1/155; B60D 2001/001; B60D 1/025

(57) ABSTRACT

A mobile robotic device, a connector for connecting trailers in mobile robotic device and a method of controlling the device for yaw control and pitch control are provided. The connector includes: a first body; a second body connected to the first body and rotatable with respect to the first body about a first axis; a third body connected to the first body and rotatable with respect to the first body about a second axis; and a fourth body connected to the second body and rotatable with respect to the second body about a third axis, wherein the connector is switchable between a yaw control mode in which the second body is driven to rotate with respect to the first body in a horizontal plane and a pitch control mode in which the second body is driven to rotate with respect to the first body in a vertical plane.

### FIELD OF THE DISCLOSURE

The present disclosure relates generally to robot technology, and more particularly to a connector for connecting trailers in a mobile robotic device, a mobile robotic device having the same, and a method of controlling the mobile robotic device.

### BACKGROUND OF THE DISCLOSURE

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Mobile robotic devices have been applied to convey objects for example in an automated factory or an automated warehouse. The mobile robotic devices may include trailers for carrying objects. The trailers are typically designed to be passively connected. In other words, the relative positions of the trailers are not controlled by any actuators such as motors. In such a design, the control uncertainty increases when the trailer number increases, and there is a limited number of trailers that can be connected to a mobile robotic device

Therefore, an unaddressed need exists in the art to address the aforementioned deficiencies and inadequacies.

### SUMMARY OF THE DISCLOSURE

In one aspect, the disclosure is directed to a connector for connecting trailers in a mobile robotic device. In certain embodiments, the connector includes: a first body; a second body which is connected to the first body and rotatable with respect to the first body about a first axis; a third body which is connected to the first body and rotatable with respect to the first body about a second axis; and a fourth body which is connected to the second body and rotatable with respect to the second body about a third axis, wherein the connector is switchable between a yaw control mode in which the second body is driven to rotate with respect to the first body in a horizontal plane and a pitch control mode in which the second body is driven to rotate with respect to the first body in a vertical plane.

In certain embodiments, in the yaw control mode, the first body is at a first position with respect to the third body and the second body is at a second position with respect to the fourth body; and in the pitch control mode, the first body is at a third position with respect to the third body and the second body is at a fourth position with respect to the fourth body, wherein rotation angle difference between the first position and the third position of the first body is substantially 90 degrees and rotation angle difference between the second position and the fourth position of the second body is substantially 90 degrees.

In certain embodiments, the connector further includes: a first rotation shaft fixed to the second body and rotatably connected to the first body; and a first servo-motor configured to drive the first rotation shaft to rotate the second body with respect to the first body about the first axis.

In certain embodiments, the first servo-motor is arranged in the first body.

In certain embodiments, the connector further includes: a second rotation shaft fixed to the first body and rotatably connected to the third body; and a second servo-motor configured to drive the second rotation shaft to rotate the first body with respect to the third body about the second axis such that the connector is switched between the yaw control mode and the pitch control mode.

In certain embodiments, the second servo-motor is arranged in the third body.

In certain embodiments, the connector further includes: a controller configured to drive the second servo-motor to switch the connector between the yaw control mode and the pitch control mode and configured to drive the first servo-motor to adjust an angle of the first body with respect to the second body.

In certain embodiments, the connector further includes: a third rotation shaft fixed to the second body and rotatably connected to the fourth body; and a third servo-motor configured to drive the third rotation shaft to rotate the second body with respect to the fourth body about the third axis such that the connector is switched between the yaw control mode and the pitch control mode.

In certain embodiments, the third servo-motor is arranged in the fourth body.

In certain embodiments, the connector further includes: a controller configured to drive the third servo-motor to switch the connector between the yaw control mode and the pitch control mode and configured to drive the first servo-motor to adjust an angle of the first body with respect to the second body.

In certain embodiments, each of the second axis and the third axis is perpendicular to the first axis.

In certain embodiments, the connector further includes a fifth body which is connected to the fourth body and rotatable with respect to the fourth body about a fourth axis, wherein the fifth body is attached with one of the trailers and the third body is attached with another of the trailers.

In certain embodiments, the fourth axis is perpendicular to the third axis.

In a further aspect, the present disclosure relates to a mobile robotic device. In certain embodiments, the mobile robotic device includes: trailers; the connector as described in any one of the above embodiments, the connector being arranged to connect adjacent trailers; and a controller configured to control the connector to be switched between the yaw control mode and the pitch control mode.

In certain embodiments, the mobile robotic device further includes: a sensor configured to generate data on location of the trailers or scenes around the trailers, where the controller is configured to receive the data generated by the sensor and configured to switch the connector to the yaw control mode or maintain the connector in the yaw control mode when the trailers travel on a bending track.

In certain embodiments, the controller is configured to switch the connector to the pitch control mode or maintain the connector in the pitch control mode when the trailers meet an obstacle with a height lower than a predetermined threshold.

In certain embodiments, the sensor comprises an image sensor, a distance sensor or a wheel angle sensor.

In certain embodiments, at least one of the trailers comprises: drive wheels.

In a further aspect, the present disclosure relates to a method of controlling a mobile robotic device comprising the connector described above. In certain embodiments, the method includes: switching the connector to the yaw control mode or maintain the connector in the yaw control mode when trailers that are connected by the connector in the mobile robotic device travel on a bending track; and switching the connector to the pitch control mode or maintain the connector in the pitch control mode when trailers that are connected by the connector in the mobile robotic device meet an obstacle with a height lower than a predetermined threshold.

In certain embodiments, two adjacent trailers are connected by the connector and in the yaw control mode, one of the two adjacent trailers is displaceable with respect to the other in the horizontal direction and in the pitch control mode, one of the two adjacent trailers is displaceable with respect to the other in the vertical direction.

These and other aspects of the present disclosure will become apparent from following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings. These accompanying drawings illustrate one or more embodiments of the present disclosure and, together with the written description, serve to explain the principles of the present disclosure. Wherever possible, the same reference numbers are used throughout the drawings to refer to the same or like elements of an embodiment, and wherein:

FIG. 1 schematically depicts a connector for connecting trailers in a mobile robotic device according to certain embodiments of the present disclosure, in which the connector is in a first control mode.

FIG. 2 schematically depicts the connector shown in FIG. 1, in which the connector is in a second control mode.

FIG. 3 schematically depicts a local part of the connector shown in FIG. 1, in which the second body and the fourth body of the connector are illustrated.

FIG. 4 schematically depicts another local part of the connector shown in FIG. 1, in which the first body and the third body are illustrated.

FIG. 5 schematically depicts a mobile robotic device according to certain embodiments of the present disclosure, in which the connector is in the first control mode.

FIG. 6 schematically depicts the mobile robotic device shown in FIG. 5, in which the connector is in the second control mode.

FIG. 7 schematically depicts a block diagram of a mobile robotic device according to certain embodiments of the present disclosure.

FIG. 8 schematically depicts an exemplified connection of a servo-motor and a rotation shaft according to certain embodiments of the present disclosure.

FIG. 9 schematically depicts another exemplified connection of the servo-motor and the rotation shaft according to certain embodiments of the present disclosure.

FIG. 10 schematically depicts a flow chart of a method of controlling a mobile robotic device according to certain embodiments of the present disclosure.

FIG. 11 schematically depicts a flow chart of a method of controlling a mobile robotic device according to other certain embodiments of the present disclosure.

### DETAILED DESCRIPTION OF THE DISCLOSURE

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Further, relative terms, such as “lower” or “bottom,” “upper” or “top,” and “left” and “right,” may be used herein to describe one element's relationship to another element as illustrated in the Figures.

It will be understood that relative terms are intended to encompass different orientations of the device in addition to the orientation depicted in the figures.

As used herein, “plurality” means two or more. As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code,” as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface,” as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the present disclosure are shown. This disclosure may, however, be embodied in many different forms and should not be construed as limited to the embodiments set forth herein; rather, these embodiments are provided so that this disclosure will be thorough and complete, and will fully convey the scope of the present disclosure to those skilled in the art.

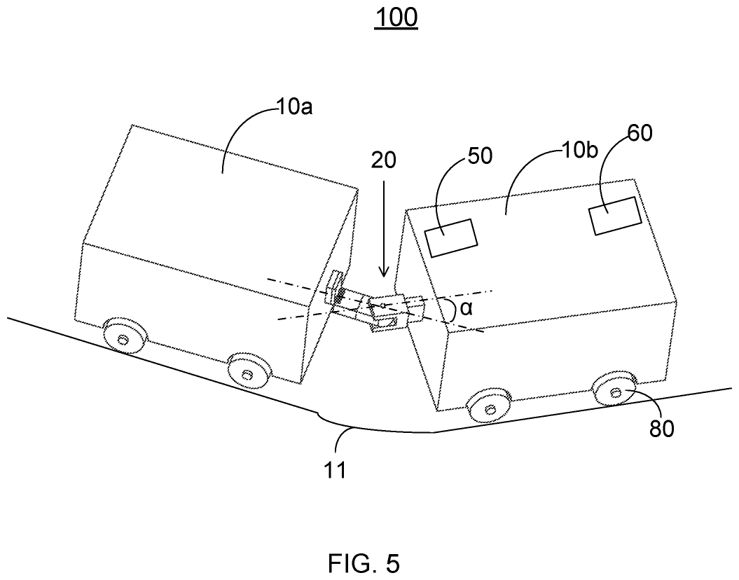

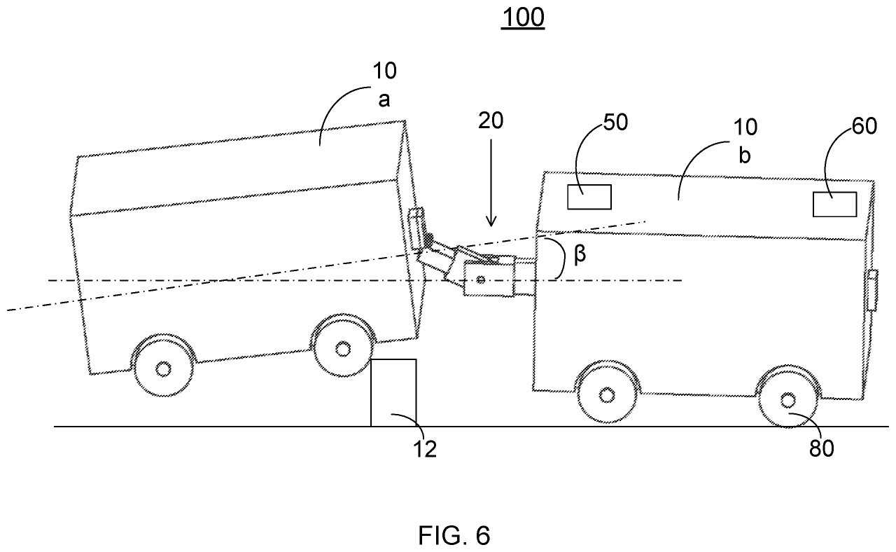

FIGS. 5 and 6 schematically depict a mobile robotic device 100 according to certain embodiments of the present disclosure, where the mobile robotic device 100 is switchable between a first mode as shown in FIG. 5 and a second mode as shown in FIG. 6. In FIGS. 5 and 6, the mobile robotic device 100 includes a first trailer 10a and a second trailer 10b connected with each other by a connector 20. As shown in FIG. 5, the mobile robotic device 100 is turning, i.e., it is moving along a bending track 11. During the move of the mobile robotic device 100 along the bending track 11, the first trailer 10a and the second trailer 10b are displaced with respect to each other in horizontal direction. In the embodiments, the connector 20 connecting the first trailer 10a with the second trailer 10b can change an angle α between a travel direction of the first trailer 10a and a travel direction of the second trailer 10b in a horizontal plane such that the mobile robotic device 100 can turn easily. In the case shown in FIG. 5, the connector 20 is in the first mode, that is, yaw control mode. In the yaw control mode, the travel direction of the second trailer 10b may be controlled to change with respect to the travel direction of the first trailer 10a in the horizontal direction.

Please be noted that the term of “track” is the path along which the mobile robotic device 100 moves. In certain embodiments, the mobile robotic device 100 may move on a real guide rail. Alternatively, the mobile robotic device 100 may move for example along a line drawn on the ground or a virtual line. Such a drawn line or virtual line can also be regarded as “track.”

In certain embodiments, as shown in FIG. 6, the mobile robotic device 100 is passing over an obstacle 12 with a certain height. In order that the mobile robotic device 100 can pass over the obstacle 12, the first trailer 10a needs to be raised with respect to the second trailer 10b, i.e., needs to move with respect to the second trailer 10b in the vertical direction. In the embodiments, the connector 20 connecting the first trailer 10a with the second trailer 10b can change an angle θ between a travel direction of the first trailer 10a and a travel direction of the second trailer 10b in a vertical direction such that the mobile robotic device 100 can pass over the obstacle. In the case shown in FIG. 6, the connector 20 is in the second mode, that is, pitch control mode. In the pitch control mode, the travel direction of the second trailer 10b may be controlled to change with respect to the travel direction of the first trailer 10a in the vertical direction.

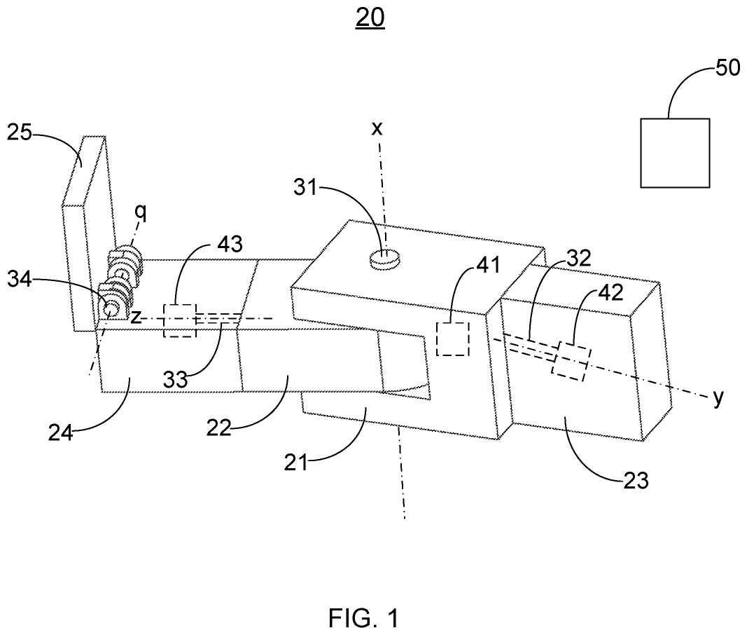

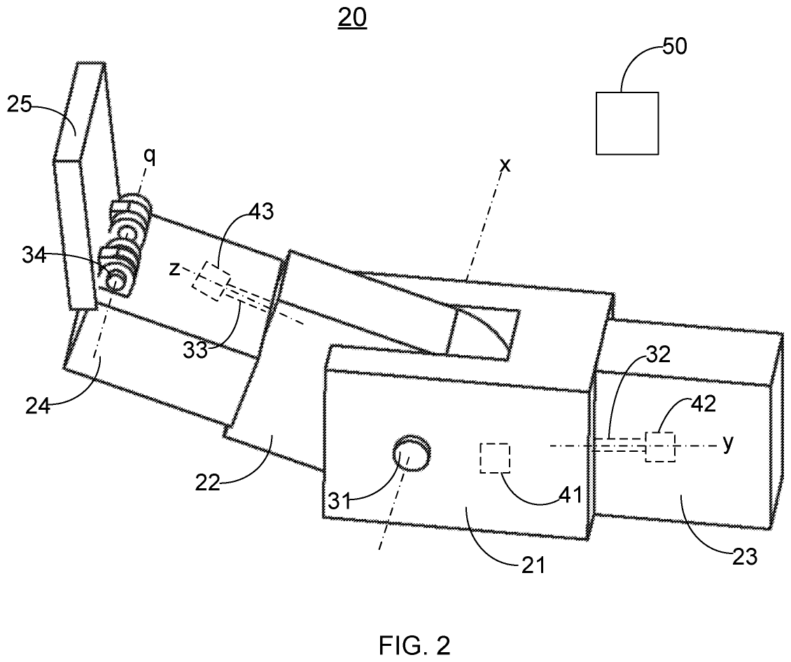

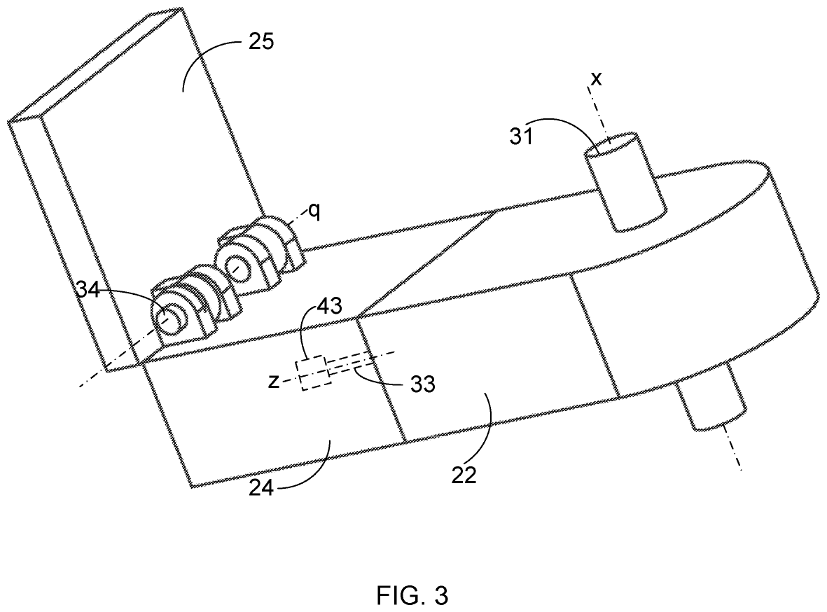

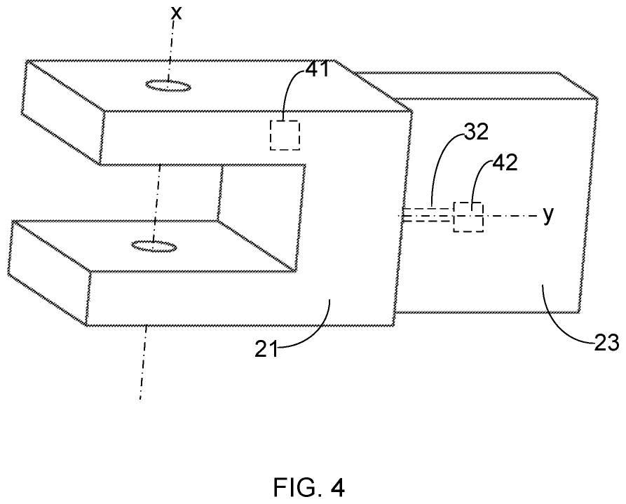

Next, the connector 20 according to embodiments of the present disclosure will be explained with reference to FIGS. 1 to 4.

FIG. 1 shows schematically the connector 20 for connecting trailers in a mobile robotic device 100 according to certain embodiments of the present disclosure. The connector 20 includes a first body 21, a second body 22, a third body 23 and a fourth body 24. In certain embodiments, the second body 22 is connected to the first body 21 and rotatable with respect to the first body 21 about a first axis x; the third body 23 is connected to the first body 21 and rotatable with respect to the first body 21 about a second axis y; and the fourth body 24 is connected to the second body 22 and rotatable with respect to the second body 22 about a third axis z. By means of the above arrangement, the connector 20 is switchable between the yaw control mode and the pitch control mode. In the yaw control mode, the second body 22 is driven to rotate with respect to the first body 21 in the horizontal plane. In the pitch control mode, the second body 22 is driven to rotate with respect to the first body 21 in the vertical plane. As an example, each of the second axis y and the third axis z is substantially perpendicular to the first axis x.

With the above structure of the connector 20, one of the first trailer 10a and the second trailer 10b connected by the connector 20 can be driven to move with respect to the other one such that each of these trailers has a posture that can be adjusted actively and accurately. The connector 20 according to certain embodiments of the present disclosure can reduce uncertainty of design of the mobile robotic device 100 and increase reliability of the device in particular if the device includes many trailers.

In certain embodiments, the connection between the first body 21 and the second body 22 can be achieved by a first rotation shaft 31. The first rotation shaft 31 may be fixed to the second body 22 and rotatably connected to the first body 21. The first rotation shaft 31 can be connected to the first body 21 by means of any known rotatable connecting structures such as bearings. In order to drive the first rotation shaft 31 and the second body 22 to rotate with respect to the first body 21, the connector 20 may further include a first servo-motor 41. In an example, the first servo-motor 41 may be arranged in the first body 21. The first servo-motor 41 can be configured to drive the first rotation shaft 31 to rotate the second body 22 with respect to the first body 21 about the first axis x. Alternatively, the first rotation shaft 31 may be fixed to the first body 21 and rotatably connected to the second body 22. As such, the first servo-motor 41 may alternatively be arranged in the second body 22.

In certain embodiments, the connection between the first body 21 and the third body 23 can be achieved by a second rotation shaft 32. The second rotation shaft 32 may be fixed to the first body 21 and rotatably connected to the third body 23. Similar to the first rotation shaft 31, the second rotation shaft 32 can be connected to the third body 23 by means of any known rotatable connecting structures such as bearings. The connector 20 may further include a second servo-motor 42 configured to drive the second rotation shaft 32 to rotate the first body 21 with respect to the third body 23 about the second axis y such that the connector 20 is switched between the yaw control mode and the pitch control mode. In an example, the second servo-motor 42 may be arranged in the third body 23. Alternatively, the second rotation shaft 32 may be fixed to the third body 23 and rotatably connected to the first body 21. As such, the second servo-motor 42 may alternatively be arranged in the first body 21.

In certain embodiments, in the yaw control mode, the first body 21 is at a first position with respect to the third body 23 and the second body 22 is at a second position with respect to the fourth body 24. Correspondingly, in the pitch control mode, the first body 21 is at a third position with respect to the third body 23 and the second body 22 is at a fourth position with respect to the fourth body 24. In certain embodiments, rotation angle difference between the first position and the third position of the first body 21 is substantially 90 degrees and rotation angle difference between the second position and the fourth position of the second body 22 is substantially 90 degrees. The term of “rotation angle difference between the first position and the third position of the first body” means an angle by which the first body rotates from the first position to the third position. In the above example, the first body 21 needs to rotate by substantially 90 degrees (such as 80 degrees to 100 degrees) from the first position to the third position. As such, the term of “rotation angle difference between the second position and the fourth position of the second body” means an angle by which the second body rotates from the second position to the fourth position. In the above example, the second body 22 needs to rotate by substantially 90 degrees (such as 80 degrees to 100 degrees) from the second position to the fourth position. In this way, the connector 20 may switch between the yaw control mode and the pitch control mode correctly. Please be noted that each of the rotation angle difference between the first position and the third position of the first body and the rotation angle difference between the second position and the fourth position of the second body is not limited to “substantially 90 degrees.” In certain embodiments, the rotation angle difference can be other numerical values as the circumstance requires.

In certain embodiments, the connector 20 may further include a fifth body 25. The fifth body 25 is connected to the fourth body 24 and rotatable with respect to the fourth body 24 about a fourth axis q. The fifth body 25 may be attached with one of the trailers (such as the first trailer 10a) and the third body 23 is attached with another of the trailers (such as the second trailer 10b). In certain embodiments, the fourth axis q is perpendicular to the third axis z.

In certain embodiments, the connection between the second body 22 and the fourth body 24 can be achieved by a third rotation shaft 33. The third rotation shaft 33 may be fixed to the second body 22 and rotatably connected to the fourth body 24. Similar to the second rotation shaft 32, the third rotation shaft 33 can be connected to the fourth body 24 by means of any known rotatable connecting structures such as bearings.

In certain embodiments, the connector 20 may further include a third servo-motor 43 configured to drive the third rotation shaft 33 to rotate the second body 22 with respect to the fourth body 24 about the third axis z such that the connector 20 can be switched between the yaw control mode and the pitch control mode. In an example, the third servo-motor 43 may be arranged in the fourth body 24. Alternatively, the third rotation shaft 33 may be fixed to the fourth body 24 and rotatably connected to the second body 22. As such, the third servo-motor 43 may alternatively be arranged in the second body 22.

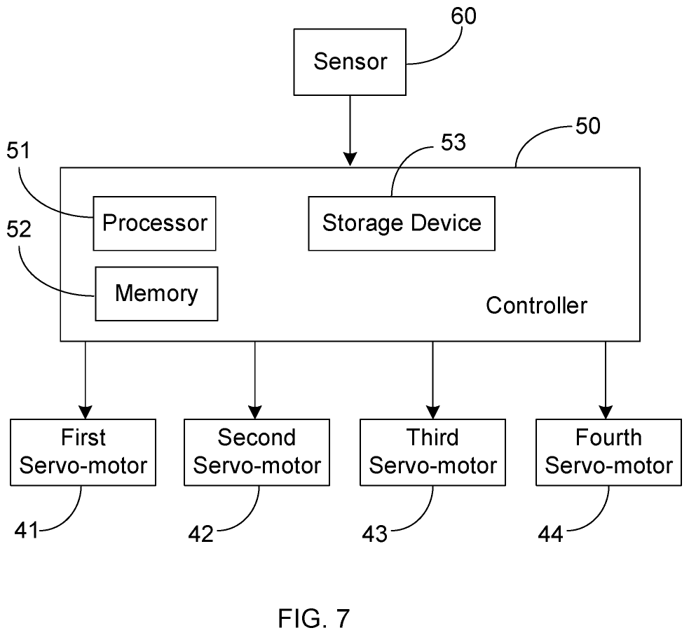

As shown in FIG. 7, the connector 20 may further include a controller 50 configured to drive the second servo-motor 42 to switch the connector 20 between the yaw control mode and the pitch control mode and configured to drive the first servo-motor 41 to adjust an angle of the first body 21 with respect to the second body 22. As an example, the controller 50 may also be configured to drive the third servo-motor 43 to switch the connector 20 between the yaw control mode and the pitch control mode and configured to drive the first servo-motor 41 to adjust an angle of the first body 21 with respect to the second body 22. The controller 50 may be assembled in the connector 20. Alternatively, the connector 20 may be linked with a separate controller, for example a remote controller. The separate controller may communicate with any of the above servo-motors by wires or wirelessly. As an example, the controller 50 may receive environmental information from a sensor 60, such as an image sensor, a distance sensor or a wheel angle sensor.

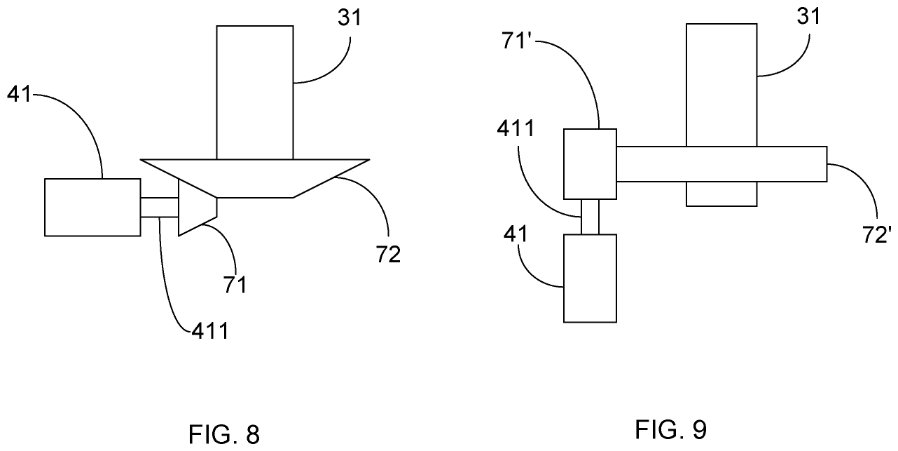

FIG. 8 shows schematically an exemplified connection between the first servo-motor 41 and the first rotation shaft 31. In this example, the first servo-motor 41 has an output shaft 411 connected to a first bevel gear 71. The first rotation shaft 31 is connected to a second bevel gear 72. The first bevel gear 71 is engaged with the second bevel gear 72. The first servo-motor 41 is configured to drive the first bevel gear 71 to rotate. And the rotation of the first bevel gear 71 can be transmitted to the second bevel gear 72 such that the first rotation shaft 31 can be driven to rotate. FIG. 9 shows schematically another exemplified connection between the first servo-motor 41 and the first rotation shaft 31. In comparison with the example shown in FIG. 8, the first bevel gear 71 and the second bevel gear 72 are replaced by a first spur gear 71′ and a second spur gear 72′ shown in FIG. 9. By means of the engagement between the first spur gear 71′ and the second spur gear 72′, the first servo-motor 41 can drive the first rotation shaft 31 to rotate, similar to the above example shown in FIG. 8. The connection between the first servo-motor 41 and the first rotation shaft 31 is not limited to the above examples, and any known drive transmission system in the art can be used to transmit the rotation movement outputted by the first servo-motor 41 to the first rotation shaft 31. The connection between the second servo-motor 42 and the second rotation shaft 32 and the connection between the third servo-motor 43 and the third rotation shaft 33 are similar to the above connection between the first servo-motor 41 and the first rotation shaft 31.

Referring back to FIGS. 5 and 6, the mobile robotic device 100 may include: trailers such as the first trailer 10a and the second trailer 10b; the connector 20 is arranged to connect adjacent first trailer 10a and second trailer 10b; and a controller 50 is configured to control the connector 20 to be switched between the yaw control mode and the pitch control mode.

The connector 20 may have any structures according to the above embodiments. With such arrangement, movements and postures of the trailers in the mobile robotic device 100 can be controlled accurately and reliably.

In certain embodiments, the mobile robotic device 100 may further include a sensor 60 configured to generate data on location of the trailers or scenes around the trailers. The data on location of the trailers may include, for example, travel distance of the trailers, position coordinates of the trailers or cycle number of wheels of the trailers. The data on scenes around the trailers may include, for example images of road or data regarding obstacles at the front of the trailers. As an example, the sensor may include an image sensor, a distance sensor or a wheel angle sensor. The image sensor may generate images of scenes around the trailers. The distance sensor may measure the travel distance of the trailers. The wheel angle sensor may count the accumulated angles by which a certain wheel of a trailer.

In certain embodiments, the controller 20 is configured to receive the data generated by the sensor 60 and configured to switch the connector 20 to the yaw control mode or maintain the connector 20 in the yaw control mode when the trailers travel on a bending track.

Similarly, the controller may also be configured to switch the connector 20 to the pitch control mode or maintain the connector 20 in the pitch control mode when the trailers meet an obstacle with a height lower than a predetermined threshold. The predetermined threshold can be determined by the user as required. For example, it may be determined as more than radius of certain wheels of the trailers.

In certain embodiments, the yaw control mode is the default mode of the connector 20.

In certain embodiments, at least one of the trailers includes: one or more drive wheels 80. The drive wheels 80 can drive the trailers to move. Typically, the drive wheels 80 may be provided on the leading trailer (the first one from the head of the device). However, embodiments of the present disclosure are not limited to this, alternatively, the drive wheels 80 may be provided on any of the trailers.

Although the above description explains the concept of the present disclosure with reference to two trailers in one mobile robotic device, embodiments of the present disclosure are not limited to this. Alternatively, one mobile robotic device may include any number of trailers. Utilization of the connector 20 allows the mobile robotic device to have more trailers, as discussed above.

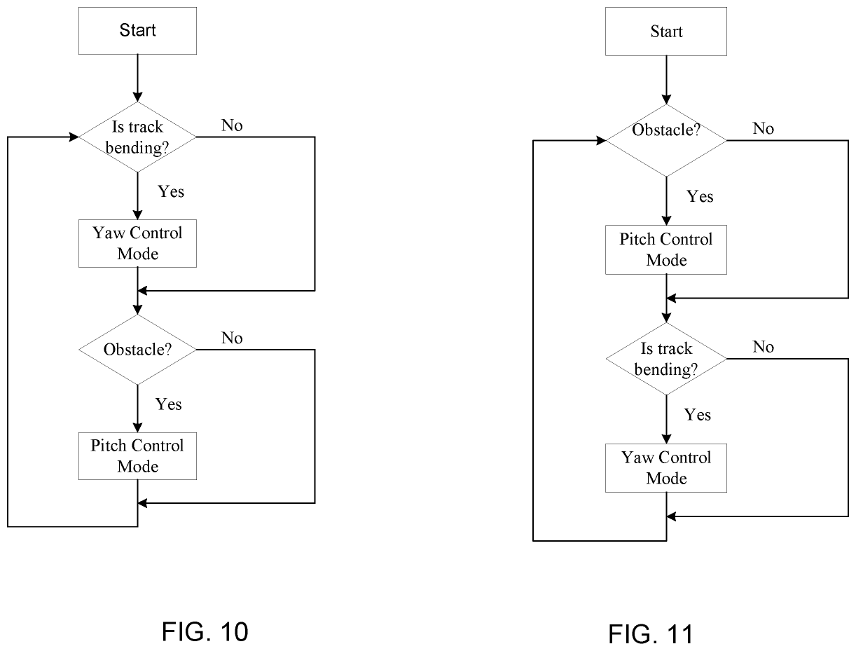

In certain aspects, the present disclosure provides a method of controlling a mobile robotic device. In certain embodiments, as shown in FIG. 10, the method may include:

deciding whether trailers that are connected by the connectors in the mobile robotic device travel on a bending track, and if yes, switching the connector to the yaw control mode or maintaining the connector in the yaw control mode; and deciding whether trailers that are connected by the connectors in the mobile robotic device meet an obstacle with a height lower than a predetermined threshold, and if yes, switching the connector to the pitch control mode or maintaining the connector in the pitch control mode.

Alternatively, the above steps can be interchanged. For example, as shown in FIG. 11, the method may include:
deciding whether trailers that are connected by the connector in the mobile robotic device meet an obstacle with a height lower than a predetermined threshold, and if yes, switching the connector to the pitch control mode or maintaining the connector in the pitch control mode; and deciding whether trailers that are connected by the connector in the mobile robotic device travels on a bending track, and if yes, switching the connector to the yaw control mode or maintaining the connector in the yaw control mode.

In the above method, two adjacent trailers are connected by the connector. In the yaw control mode, one of the two adjacent trailers is displaceable with respect to the other in the horizontal direction. In the pitch control mode, one of the two adjacent trailers is displaceable with respect to the other in the vertical direction.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A connector for connecting trailers in a mobile robotic device, comprising:
a first body;
a second body which is connected to the first body and rotatable with respect to the first body about a first axis;
a third body which is connected to the first body and rotatable with respect to the first body about a second axis; and
a fourth body which is connected to the second body and rotatable with respect to the second body about a third axis,
wherein the connector is switchable between a yaw control mode in which the second body is driven to rotate with respect to the first body in a horizontal plane and a pitch control mode in which the second body is driven to rotate with respect to the first body in a vertical plane.

2. The connector of claim 1, wherein in the yaw control mode, the first body is at a first position with respect to the third body and the second body is at a second position with respect to the fourth body; and in the pitch control mode, the first body is at a third position with respect to the third body and the second body is at a fourth position with respect to the fourth body, wherein rotation angle difference between the first position and the third position of the first body is substantially 90 degrees and rotation angle difference between the second position and the fourth position of the second body is substantially 90 degrees.

3. The connector of claim 1, further comprising:
a first rotation shaft fixed to the second body and rotatably connected to the first body; and
a first servo-motor configured to drive the first rotation shaft to rotate the second body with respect to the first body about the first axis.

4. The connector of claim 3, wherein the first servo-motor is arranged in the first body.

5. The connector of claim 3, further comprising:
a second rotation shaft fixed to the first body and rotatably connected to the third body; and
a second servo-motor configured to drive the second rotation shaft to rotate the first body with respect to the third body about the second axis such that the connector is switched between the yaw control mode and the pitch control mode.

6. The connector of claim 5, wherein the second servo-motor is arranged in the third body.

7. The connector of claim 5, further comprising: a controller configured to drive the second servo-motor to switch the connector between the yaw control mode and the pitch control mode and configured to drive the first servo-motor to adjust an angle of the first body with respect to the second body.

8. The connector of claim 3, further comprising:
a third rotation shaft fixed to the second body and rotatably connected to the fourth body; and
a third servo-motor configured to drive the third rotation shaft to rotate the second body with respect to the fourth body about the third axis such that the connector is switched between the yaw control mode and the pitch control mode.

9. The connector of claim 8, wherein the third servo-motor is arranged in the fourth body.

10. The connector of claim 8, further comprising: a controller configured to drive the third servo-motor to switch the connector between the yaw control mode and the pitch control mode and configured to drive the first servo-motor to adjust an angle of the first body with respect to the second body.

11. The connector of claim 1, wherein each of the second axis and the third axis is perpendicular to the first axis.

12. The connector of claim 1, further comprising a fifth body which is connected to the fourth body and rotatable with respect to the fourth body about a fourth axis, wherein the fifth body is attached with one of the trailers and the third body is attached with another of the trailers.

13. The connector of claim 12, wherein the fourth axis is perpendicular to the third axis.

14. A mobile robotic device comprising:
trailers;
the connector of claim 1, the connector being arranged to connect adjacent trailers; and
a controller configured to control the connector to be switched between the yaw control mode and the pitch control mode.

15. The mobile robotic device of claim 14, further comprising:
a sensor configured to generate data on location of the trailers or scenes around the trailers,
wherein the controller is configured to receive the data generated by the sensor and configured to switch the connector to the yaw control mode or maintain the connector in the yaw control mode when the trailers travel on a bending track.

16. The mobile robotic device of claim 15, wherein the controller is configured to switch the connector to the pitch control mode or maintain the connector in the pitch control mode when the trailers meet an obstacle with a height lower than a predetermined threshold.

17. The mobile robotic device of claim 15, wherein the sensor comprises an image sensor, a distance sensor or a wheel angle sensor.

18. The mobile robotic device of claim 15, wherein at least one of the trailers further comprises drive wheels.

19. A method of controlling a mobile robotic device comprising the connector of claim 1, the method comprising:
switching the connector to the yaw control mode or maintaining the connector in the yaw control mode when trailers that are connected by the connector in the mobile robotic device travel on a bending track; and
switching the connector to the pitch control mode or maintaining the connector in the pitch control mode when trailers that are connected by the connector in the mobile robotic device meet an obstacle with a height lower than a predetermined threshold.

20. The method of claim 19,
wherein two adjacent trailers are connected by the connector;
wherein in the yaw control mode, one of the two adjacent trailers is displaceable with respect to the other in the horizontal direction; and
wherein in the pitch control mode, one of the two adjacent trailers is displaceable with respect to the other in the vertical direction.
